(19) United States
(12) Patent Application Publication
(10) Pub. No.: US 2005/0173545 A1
(43) Pub. Date: Aug. 11, 2005

(54) Faucet with internal thermostatic tempering device

(76) Inventors: Walter H. Strader, Coto De Caza, CA (US); Edward Pilatowicz, Anaheim Hills, CA (US); Mark S. Bloom, Mission Viejo, CA (US); Alston E. Williams, Irvine, CA (US)

Correspondence Address: Black & Decker Corporation, 701 East Joppa Road, TW 199, Towson, MD, 21286, US

(21) Appl. No.: 10/509,982

(22) PCT Filed: Apr. 3, 2003
(86) PCT No.: PCT/US03/10230

Related U.S. Application Data
(60) Provisional application No. 60/369,915, filed on Apr. 4, 2002.

(51) Int. Cl. G05D 23/13

(52) U.S. Cl. 236/12.2

(57) ABSTRACT

A faucet includes a spout having a thermostatic tempering device installed therein. The thermostatic tempering device includes a temperature-sensing element that can include a wax element.

The present invention relates to faucets in general and particularly to faucets having internal valves. More particularly, the invention relates to faucets having internal thermostatic tempering devices.

### BACKGROUND

In a conventional faucet, a user mixes hot and cold water to control the temperature of water supplied to a faucet by manipulating water control valves. Unfortunately, a small child can inadvertently supply too much hot water to the faucet which can scald the child. In addition, it is possible for the hot or cold water sources to fail, thereby mixing too much hot water or too little cold water and scalding the user.

Thermostatic tempering devices that restrict the temperature of a flow of water to a preset maximum are known. It is also known to add these valves in the flow between the hot and cold water valves and the faucet. However, such a setup requires the user to install an additional component in the plumbing system which is inconvenient. Moreover, the typical installation requires the installer to install the thermostatic tempering devices below the sink, which is typically a cramped workspace.

### SUMMARY OF THE INVENTION

The present invention overcomes these and other shortcomings of conventional thermostatic tempering device installations by providing a faucet with an internal thermostatic tempering device. Hence, an installer need only install a faucet in a conventional manner making standard connections to provide the additional protection of a thermostatic tempering device. When upgrading to a thermostatic valve, the installer need not get below the sink, since the thermostatic valve is in the faucet and above the sink.

### BRIEF DESCRIPTION OF THE DRAWINGS

FIG. 1 is a schematic view of a two-handle faucet showing an internal thermostatic tempering device.

FIG. 2 is a schematic view of a single-handle faucet showing an internal thermostatic tempering device and a flow control valve.

FIG. 3 illustrates one embodiment of the invention.

FIG. 4 illustrates another embodiment of the invention.

FIG. 5 illustrates yet another embodiment of the invention.

FIG. 6 is a top plan view of a channel member for use with the invention.

FIG. 7 is a section view taken along lines 7-7 in FIG. 5.

FIG. 8 is a bottom plan view of the channel member.

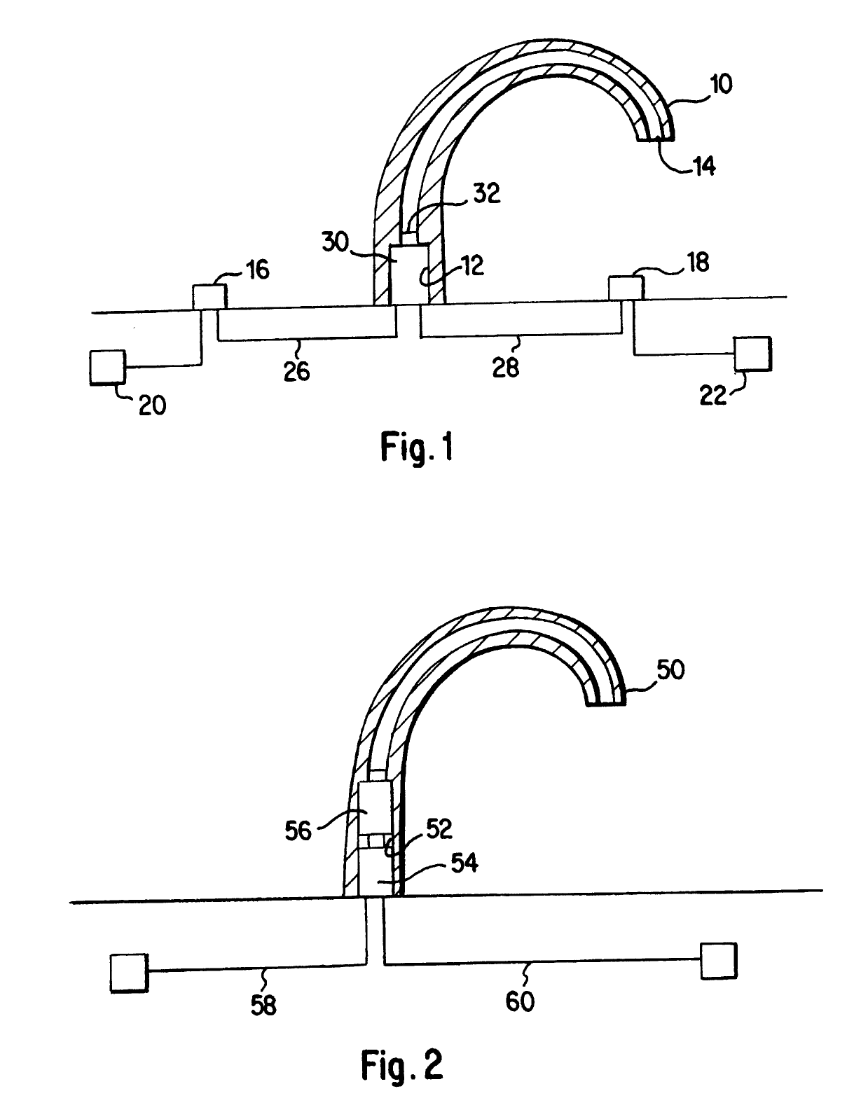

### DETAILED DESCRIPTION OF THE DRAWINGS

A faucet 10 includes a mixing area in an internal cavity 12, an outlet 14 in fluid communication with the cavity 12 and hot and cold water valves 16, 18 that connect hot and cold water sources 20, 22 with the cavity 12 by conduits 26, 28. A thermostatic tempering device 30 is disposed in the cavity 12 and receives hot and cold water inputs from conduits 26, 28, respectively. Thermostatic tempering device 30 includes an outlet 32 coupled to the faucet outlet 14.

Thermostatic tempering device 30 is preset at the factory to provide a maximum outlet temperature, regardless of the temperature of the hot water source 20, even in the event of a failure in either the hot or cold water supply systems.

FIG. 2 represents a single control faucet 50 having a mixing area 52 with a cartridge valve 54 and a thermostatic tempering device 56 disposed in the cavity 52. Hot and cold water conduits 58, 60 supply hot and cold water to the cartridge valve 54, which supplies an outlet flow of water to the thermostatic tempering device 56. The cartridge valve 54 controls the volume and temperature of the water and the thermostatic tempering device 56 ensures that the selected water temperature does not exceed a predetermined maximum temperature. Alternatively, the cartridge valve 54 can control the amount of hot and cold water passing through the cartridge valve 54.

Alternatively, it is possible to reverse the positions of the cartridge valve 54 and thermostatic tempering device 56 so that the thermostatic tempering device 56 provides water to the cartridge valve 54 at the maximum predetermined temperature. In this case, the cartridge valve 54 would select the volume of water. Either arrangement ensures that the water at the faucet outlet is tempered.

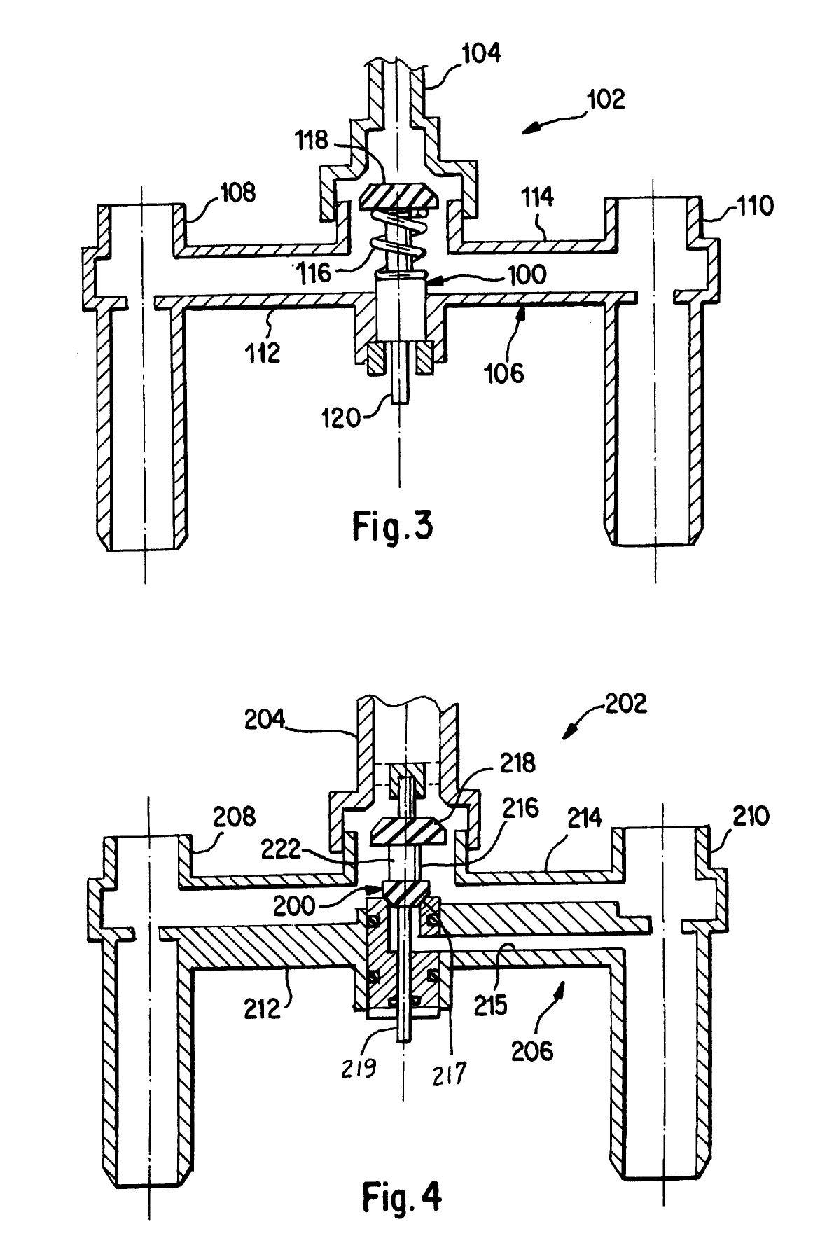

FIG. 3 illustrates an exemplary embodiment of a thermostatic tempering device 100 disposed in a faucet 102. The faucet 102 includes a spout 104 coupled to an underbody 106 that includes a pair of end bodies 108, 110 and a pair of conduits 112, 114 connecting the end bodies 108, 110 to the spout 104. Conventional flow control valves, not shown, are disposed in the end bodies 108, 110 in a conventional manner to control the flow of hot and cold water to the faucet 102. The thermostatic tempering device 100 is located in the underbody 106 at the mixing point of the faucet 102.

The thermostatic tempering device 100 includes a temperature sensing element 116 and a seal 118. The thermostatic tempering device 100 is disposed in the down stream mixed water path so that as the temperature rises, the temperature sensing element 116 activates the seal 118 to reduce or completely close off the amount of hot water entering the spout 104. If the temperature-sensing element 116 is activated, the user can reset it quickly by turning down the hot water or by increasing the cold water at the valves. Alternatively, the thermostatic tempering device 100 can include a reset activator 120 that can also act as a manual temperature adjuster.

FIG. 4 illustrates another exemplary embodiment of the invention. The faucet 202 includes a spout 204 coupled to an underbody 206 that includes a pair of end bodies 208, 210 and a pair of conduits 212, 214 connecting the end bodies 208, 210 to the spout 204. The thermostatic tempering device 200 is located in the underbody 206 at the mixing point of the faucet 202.

The underbody 206 differs from the underbody 106 in that it includes a separate channel 215 connecting the thermostatic tempering device 200 to the cold water end body 210 at a point below the valve. Thus, cold water is supplied to the thermostatic tempering device 100 regardless of the position of the cold water control valve. A manual adjustment device 216 allows the user to set a maximum temperature by adjusting the amount of cold water added to the mixed water during activation of the device.

The thermostatic tempering device 200 includes a temperature-sensing element 216. In one embodiment, the temperature-sensing element 216 can be a wax thermostatic element.

Wax thermostatic elements permit the transforming of thermal energy into mechanical energy by tapping into the large thermal expansion of waxes when they pass from the solid to the liquid state.

Typically, the wax thermostatic element includes a copper cup containing wax. In some cases, copper flakes are added to the wax to equalize heat distribution throughout the cup and act as filler. A flat rubber diaphragm is placed on the upper part of the cup and a brass guide closes the zone containing the wax. The diaphragm assures that the zone containing the wax is leak tight. The brass guide includes a central bore to receive a piston. As the wax increases in volume with increasing temperature, it distorts the diaphragm, which pushes upwards to urge the piston out of the element. The piston can return to its initial position under the action of a return spring.

As illustrated in FIG. 4, the wax thermostatic element includes a container 222, a lower seal 217, and an upper seal 218, all of which are disposed on a shaft 219. As the wax expands with increasing temperature, the thermostatic tempering device 200 moves up the shaft, moving the lower seal 217 and opening the separate channel 215 to admit additional cold water to moderate the temperature of the mixed water. In the extreme, where the additional cold water is insufficient to fully moderate the temperature of the mixed water, the movement of the thermostatic tempering device 200 urges the seal 218 to close off the water flow to the spout 204.

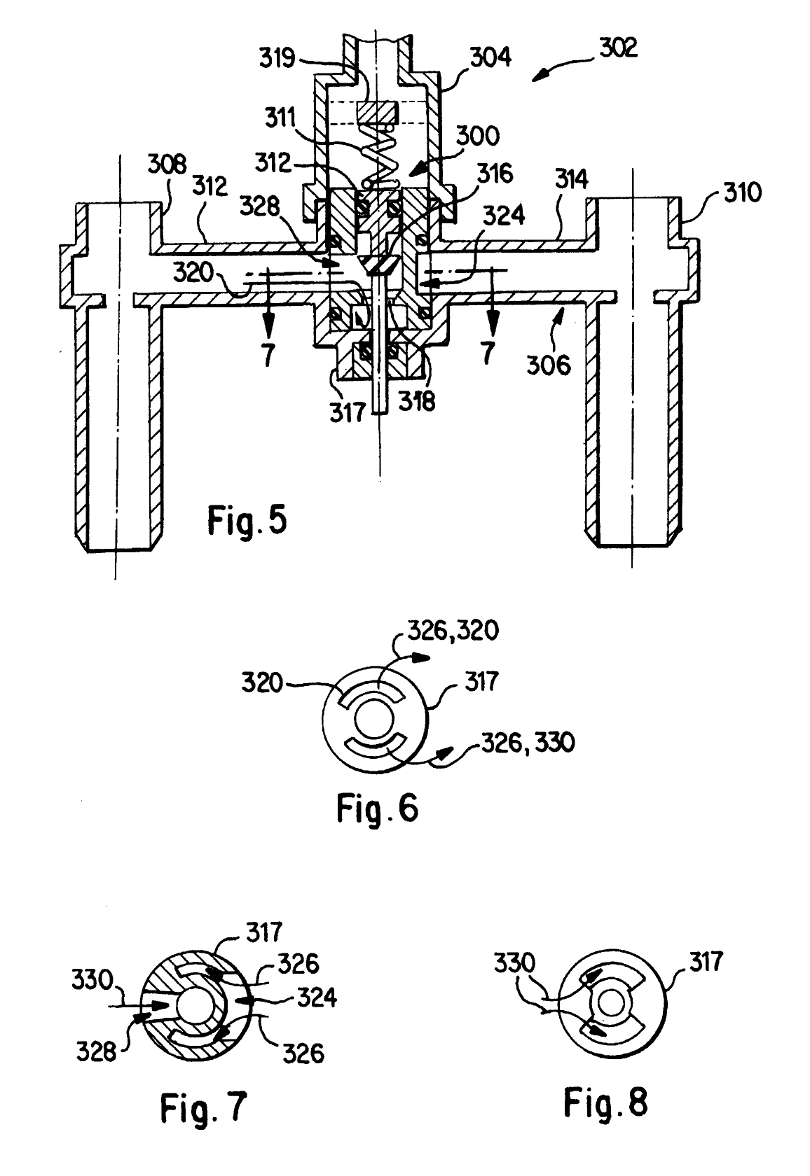

FIG. 5 illustrates yet another embodiment of the invention. The faucet 302 includes a spout 304 coupled to an underbody 306 that includes a pair of end bodies 308, 310 and a pair of conduits 312, 314 connecting the end bodies 308, 310 to the spout 304. The thermostatic tempering device 300 is located in the underbody 306 at the mixing point of the faucet 302.

The thermostatic tempering device 300 includes temperature-sensing element 311, a piston 312, and a seal 316. The piston 312 and seal 316 are disposed in a channel member 317 that defines the water path from the mixing area of the faucet to the spout 304. The temperature sensing element 311 is positioned adjacent an internal abutment member 319 formed in the spout 304, so that expansion of the temperature sensing element 311 with increasing temperature urges the piston 312 downwardly to urge the seal 316 against valve seat 318. As the seal 316 seats in the channel member 317, it cuts off the flow of hot water to the spout 304.

The channel member 317 is further illustrated in FIGS. 6-8 and includes a pair of arcuate longitudinal passages 320 that extend along the entire length of the channel member 317. It also includes a cold water inlet 324 on the right side of the channel member 317, as viewed in FIGS. 5-8. The cold water flows from the cold water inlet 324 to the longitudinal passages 320 and out the top of the channel member 317 as illustrated by arrows 326. The channel member 317 further includes a hot water inlet 328 on the left side of the channel member 317. The hot water flows into the hot water inlet 328 and down past the seat 318 to curl back up and into the longitudinal passages 320 as illustrated by arrows 330. Since the hot water must flow through the seat 318 to reach the longitudinal passages 310, movement of the seal 316 against the seat 318 shuts off the flow of hot water to the spout 304.

The above-described embodiments, of course, are not to be construed as limiting the breadth of the present invention. For example, the illustrated embodiments are directed to two-handle faucets, while the invention applies equally to single control faucets. In addition, each illustrated embodiment shows the temperature sensing element moving vertically to shut off the flow of hot water. It would be obvious to one of ordinary skill in the art that a horizontal orientation would also work to achieve the desired effect. Other modifications and alternative constructions will be apparent which are within the spirit and scope of the invention as defined in the appended claims.

1. A faucet comprising:
a spout having an internal passage and being configured to be positioned on a supporting surface and coupled to water conduits that are disposed below the supporting surface; and
a thermostatic tempering device disposed in the passage above the supporting surface.

2. The faucet of claim 1 wherein the thermostatic tempering device includes a wax motor.

3. The faucet of claim 2 wherein the wax motor includes a piston and a container having a mixture of wax and thermal conductive material disposed in the container, the wax responding to increased temperature to move the piston.

4. The faucet of claim 1 wherein the thermostatic tempering device includes a reset activator.

5. The faucet of claim 1 wherein the thermostatic tempering device includes a manual temperature adjuster.

6. A faucet comprising:
a spout with an internal mixing area for mixing hot and cold water;
a pair of end bodies configured to receive a control valve, the end bodies being coupled to the internal mixing area by a conduit;
a thermostatic tempering device disposed in the internal mixing area to limit the temperature of the mixed water.

7. The faucet of claim 6 wherein the thermostatic tempering device includes a temperature sensing element disposed in the spout to sense the temperature of the mixed water and block the flow of mixed water to the spout in response to an elevated temperature of mixed water.

8. The faucet of claim 7 wherein the temperature sensing element includes a wax thermostatic device.

9. A single control faucet comprising:
a spout having an internal passage for the flow of water;
a control valve disposed in the internal passage; and
a thermostatic tempering device disposed in the internal passage.

10. The faucet of claim 9 wherein the control valve is located upstream of the thermostatic tempering device and includes means for controlling the temperature and volume of water at the thermostatic tempering device.

11. The faucet of claim 9 wherein the control valve is located upstream of the thermostatic tempering device and includes means for controlling the amount of hot water and cold water at the thermostatic tempering device.

12. A faucet comprising:
a spout having a water passage;
an underbody coupled to the spout and having a pair of end bodies and a pair of connecting conduits for conveying water from the end bodies to the spout;
a thermostatic tempering device disposed in the underbody for controlling the temperature of water conveyed to the spout.

13. A method of tempering the temperature of water exiting a faucet comprising the steps of:
providing a faucet having a spout with an internal passage;
providing a thermostatic tempering device disposed in the internal passage;
mixing hot and cold water and providing the mixed water to the thermostatic tempering device, the thermostatic tempering device restricting the flow of water to the spout in response to an increase in the water temperature.
